(19) United States
(12) Patent Application Publication
(10) Pub. No.: US 2006/0139637 A1
(43) Pub. Date: Jun. 29, 2006

(54) Hybrid lens unit and hybrid lens array

(75) Inventors: Eun-hyoung Cho, Seoul (KR); Myung-bok Lee, Suwon-si (KR); Jin-seung Sohn, Seoul (KR); Mee-suk Jung, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electro-Mechanics Co., Ltd.

(21) Appl. No.: 11/282,562

(22) Filed: Nov. 21, 2005

(30) Foreign Application Priority Data
Dec. 23, 2004 (KR) 10-2004-0111372

(51) Int. Cl. G01J 3/28

(52) U.S. Cl. 356/328

(57) ABSTRACT

A hybrid lens unit and a hybrid lens array capable of correcting chromatic aberration and that can be manufactured easily are provided. The unit includes a lens holder, a refraction lens, and a diffraction lens part. The lens holder includes a beam passing cavity having a lens mounting groove on an upper portion of the beam passing cavity. The refraction lens has a plane portion mounted into the lens mounting groove and an aspherical portion inserted into the beam passing cavity. The diffraction lens part is coupled to a lower surface of the lens holder so as to face the aspherical portion. With such a construction, the unit can correct chromatic aberration generated from the refraction lens using the diffraction lens part and has a structure that makes mass-production possible.

### CROSS-REFERENCE TO RELATED PATENT APPLICATION

This application claims the benefit of Korean Patent Application No. 10-2004-0111372, filed on Dec. 23, 2004, in the Korean Intellectual Property Office, the disclosure of which is incorporated herein in its entirety by reference.

### BACKGROUND OF THE INVENTION

1. Field of the Invention

The present invention relates to a hybrid lens unit and a hybrid lens array, and more particularly, to a hybrid lens unit and a hybrid lens array that can correct chromatic aberration and be manufactured in an easy manner.

2. Description of the Related Art

In an optical pickup recording/playing information to/from an optical disk, a microlens can be used for: a light condensing member for the optical disk; a light condensing member for coupling with a light receiving element; a light condensing member or an imaging member condensing incident light to a photoelectric transformation region in order to improve sensitivity of a solid state imagenary such as a charge coupled device (CCD) or a one-dimensional (1-D) image sensor used for a facsimile; an imaging member imaging an image to be perceived on a photosensitive member in a printer; and a filter for processing optical information.

Also, the microlens can be used for optical communication systems and optical information processing devices.

An objective lens used for an optical pickup of an optical information storage apparatus condenses a laser beam emitted from a semiconductor laser used as a light source, allows the laser beam to be focused on a recording surface of a disk to record information on the disk, or condenses and directs the laser beam reflected from the disk to an optical detector to reproduce the recorded information. Generally, a diameter of an optical information storage medium is about 120 mm, and a storage capacity has developed from 650 mega byte (MB) of CD to 4.7 gigabyte (GB) of DVD. Now, a blue-ray disk having a storage capacity of more than 25 GB is under development.

In an information recording and/or playing system for recording and/or playing information to and/or from an information storage medium using an optical spot condensed by an objective lens, an information storage capacity is determined by a condensed optical spot size. The optical spot size S is given by
S ∝ λ/NA [Equation 1]

where λ is the wavelength of a laser beam used by the apparatus and NA is the numerical aperture of the objective lens.

Therefore, research is being carried out to adopt a light source having a short wavelength such as a blue laser and an objective lens having an NA greater than 0.6, in order to reduce the optical spot size focused on the information storage medium and to meet a high-density requirement of the information storage medium.

Significant research for increasing information storage capacity by increasing a recording density have been made since the introduction of a compact disk (CD) in which recording and/or playing of information is performed using light of a wavelength of 780 nm and an objective lens whose NA is 0.45 or 0.5. As a result of such research, a digital versatile disk (DVD) such that recording and/or playing of information is performed using light of a wavelength of 650 nm and an objective lens whose NA is 0.6 or 0.65 has been developed.

Currently, development of a high-density optical information storage medium having a recoding capacity of more than 20 gigabyte (GB) using light of a blue wavelength, e.g., a wavelength of 405 nm is constantly carried out.

Standardization of the high-density optical information storage medium that uses light of a blue wavelength, e.g., a wavelength of 405 nm, is in active progress and part of the standards has been almost completed. At this point, the NA of the objective lens for the high-density information storage medium is 0.65 or 0.85.

In the meantime, the refractive index of the objective lens remarkably changes depending on the wavelength of the laser beam. The remarkable change called chromatic aberration appears because the focal length of the objective lens focused on an optical disk changes due to sequential change of the wavelength according to a mode hopping of a laser diode. Double-faced convex objective lens has been generally used to reduce the chromatic aberration in the related art.

The two-sided convex objective lens has been manufactured by a method of manufacturing the objective lens in the form of a single microlens using a mechanical processing method or by a method of manufacturing the objective lens in the form of a microlens array using a photo process that uses a photosensitizer.

FIG. 1 is a schematic view of a related art method of manufacturing a single microlens using a mechanical processing method. As illustrated in FIG. 1, an upper mold 11 and a lower mold 13 are processed in the form of a lens' surface to mold a single microlens. A lens of a ball shape or gab shape in the inside of the upper and lower molds 11 and 13 is inserted between the upper and lower molds 11 and 13 and compression is applied at high pressure and high temperature, so that the lens is molded. The mechanical processing method molds a lens using mainly glass. In the case of manufacturing a lens using plastic, the lens is molded through an injection molding using a fine mold by the mechanical process. The mechanical processing method has an advantage that very precise surface processing is possible. However, the mechanical processing method has limitations in processing the microlens whose size is small and in manufacturing a lens in the form of an array. The mechanical processing method is used for an optical information storage apparatus requiring a high NA or part of lenses for use in optical communication.

FIGS. 2A through 2E are views illustrating a related art method of manufacturing a microlens array using a photolithography process. First, a photosensitizer 17 is spread on a substrate 15 as illustrated in FIG. 2A. After that, a mask ‘M’ of a predetermined shape is positioned on the photosensitizer 17 and an ultraviolet light is illuminated so that an exposing process may be performed as illustrated in FIG. 2B. If the exposed portion of the photosensitizer 17 is developed and etched, a photosensitizer 17a is patterned in the shape as illustrated in FIG. 2C. If heat is applied to the patterned photosensitizer 17a and the patterned photosensitizer 17a is reflow-processed, the photosensitizer 17a is shaped into a photosensitive lens 17b of a spherical lens shape as illustrated in FIG. 2D. Next, the refractive index of the photosensitive lens 17b is controlled through an ion-exchange method, so that a lens 17c is finally fabricated.

In the related art method of manufacturing the microlens using the photo process, a high sag for a high NA is not easy to realize and a processing of an aspherical surface compensating for aberration is also difficult. Further, the related art method has a disadvantage that it is difficult to manufacture a large-diameter lens having a diameter of more than 500 μm. Furthermore, in manufacturing the conventional two-sided convex microlens in the form of an array, a manufacturing process is complicated even more and the performance of the microlens manufactured in this manner is deteriorated.

### SUMMARY OF THE INVENTION

Illustrative, non-limiting exemplary embodiments of the present invention overcome the above described.

An apparatus consistent with the present invention provides a hybrid lens unit having an improved structure that can correct chromatic aberration and be manufactured easily.

An apparatus consistent with the present invention also provides a hybrid lens array in which a hybrid lens is easily assembled, an automatic alignment of an optical axis is performed, and mass-production is easily carried out.

According to an aspect of the present invention, there is provided a hybrid lens unit, which includes: a lens holder having a beam passing cavity having a lens mounting groove on an upper portion of the beam passing cavity; a refraction lens having a plane portion mounted on the lens mounting groove and an aspherical portion inserted into the beam passing cavity; a diffraction lens part coupled to a lower portion of the lens holder to face the aspherical portion.

The diffraction lens part may include a diffraction lens plate having a glass substrate and a diffraction pattern part coupled on the glass substrate and positioned to correspond to the beam passing cavity.

The diffraction pattern part may be arranged to face an outer side of the beam passing cavity.

An adhesive layer may be further provided between the glass substrate and the diffraction lens plate.

The plane portion may have a round-shaped flange on an outer circumferential surface.

The lens mounting groove may have an epoxy guide groove.

A first mark aligning a position of the diffraction lens part may be formed on the upper surface or the lower surface of the lens holder and a second mark that corresponds to the first mark may be formed on the diffraction lens part.

According to another aspect of the present invention, there is provided a hybrid lens unit having a hybrid lens used for an objective lens condensing a beam on a storage medium, the unit including: a lens holder having a beam passing cavity having a lens mounting groove on an upper portion of the beam passing cavity; a refraction lens having a plane portion mounted on the lens mounting groove to face the storage medium and an aspherical portion inserted into the beam passing cavity; and a diffraction lens part having a plane arranged to face the aspherical portion and a diffraction pattern part arranged toward an outside of the beam passing cavity, and coupled to a lower surface of the lens holder.

According to yet another aspect of the present invention, there is provided a hybrid lens unit, which includes: a lens holder having a beam passing groove; a refraction lens having a plane portion arranged toward an outside of the beam passing groove and an aspherical portion inserted into the beam passing groove; and a diffraction lens part coupled to a lower portion of the lens holder to face the aspherical portion.

The diffraction pattern part may be formed integrally with the lens holder.

According to further another aspect of the present invention, there is provided a hybrid lens array, which includes: a lens holder array where lens holders each having a beam passing cavity having a lens mounting groove on an upper portion of the beam passing cavity are arranged in an array structure; refraction lenses each having a plane portion mounted on the lens mounting groove and an aspherical portion inserted into the beam passing cavity; and a diffraction lens array having diffraction pattern parts each arranged to correspond to the beam passing cavity, and coupled to the lens holder array.

The diffraction lens array may include a glass substrate and a diffraction lens plate having a diffraction pattern part formed in an array structure.

The diffraction pattern part of the diffraction lens array may be arranged to face an outside of the beam passing cavity.

According to yet another aspect of the present invention, there is provided a hybrid lens array, which includes: a lens holder array having a lens holder having a beam passing groove and arranged in an array structure; refraction lenses having a plane portion positioned toward an outside of the beam passing groove and an aspherical portion inserted into the beam passing groove; and a diffraction lens array having diffraction pattern parts each arranged to correspond to the beam passing groove, and coupled to the lens holder array.

### BRIEF DESCRIPTION OF THE DRAWINGS

The above and other features and advantages of the present invention will become more apparent by describing in detail exemplary embodiments thereof with reference to the attached drawings in which:

FIG. 1 is a view illustrating a method of manufacturing a two-sided concave microlens according to a related art;

FIGS. 2A through 2E are views illustrating processes of a method of manufacturing a microlens according to a related art;

FIG. 3A is a view of a hybrid lens unit according to a preferred embodiment of the present invention;

FIGS. 3B through 3E are views of modifications of a hybrid lens unit according to a preferred embodiment of the present invention;

FIG. 4 is a view explaining a principle on the basis of which chromatic aberration is corrected by a hybrid microlens according to a preferred embodiment of the present invention;

FIG. 5 is a view of a hybrid lens array according to the present invention;

FIGS. 6A through 6E are views illustrating processes of manufacturing a hybrid microlens array of the present invention using an ultraviolet hardening method;

FIGS. 7A through 7E are views illustrating processes of manufacturing a hybrid microlens array of the present invention using a nano imprinting method; and

FIGS. 8 through 10 are views of modifications of a hybrid microlens array according to a preferred embodiment of the present invention.

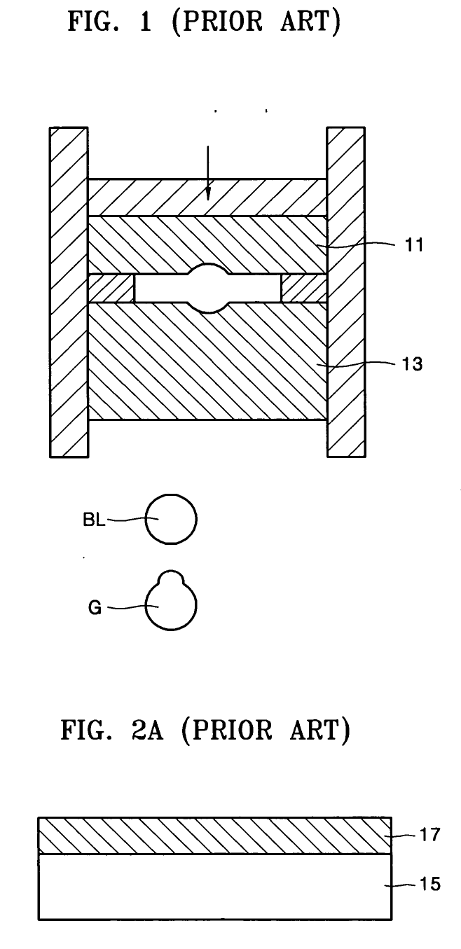

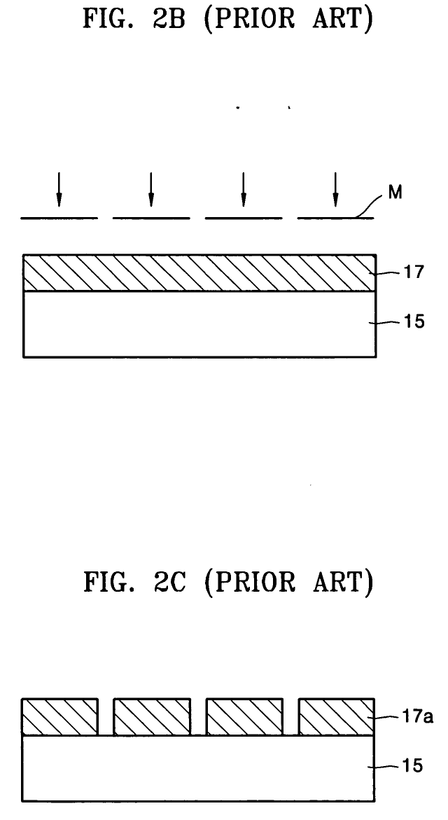

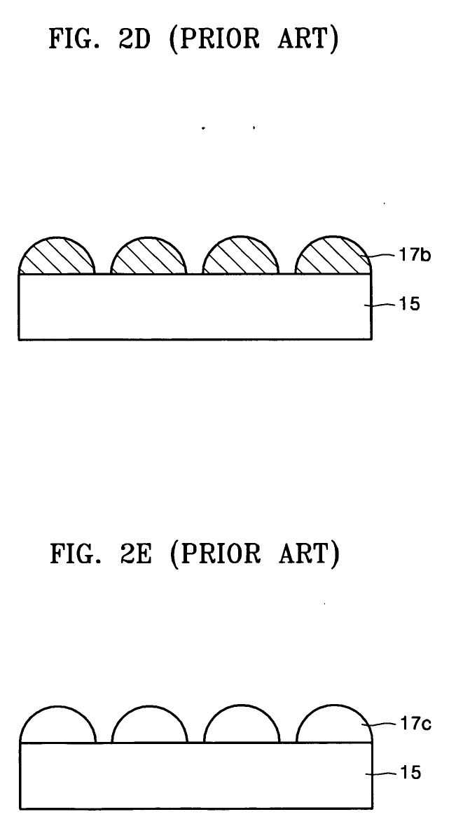

### DETAILED DESCRIPTION OF THE INVENTION

The present invention will now be described more fully with reference to the accompanying drawings, in which exemplary embodiments of the invention are shown.

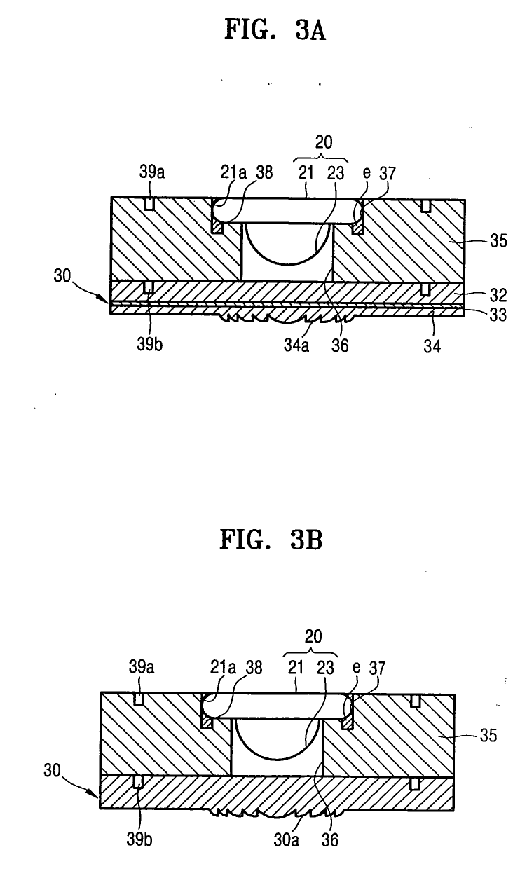

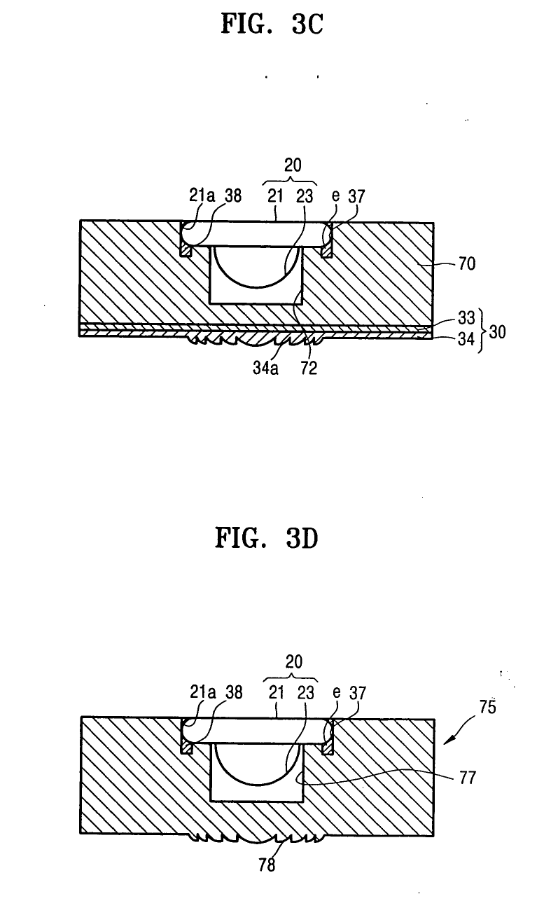

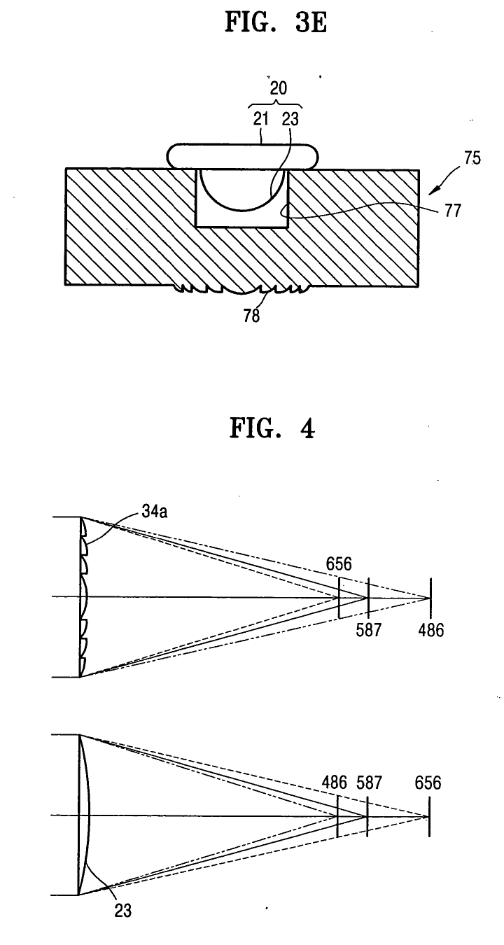

Referring to FIG. 3A, the hybrid lens unit according to the present invention includes: a refraction lens 20 whose one side is a plane surface 21 and whose other side is aspherical surface 23; a diffraction lens part 30 disposed to face the aspherical surface 23; and a lens holder 35 where the refraction lens 20 and the diffraction lens part 30 are coupled with each other. The plane surface 21 has a flange 21a.

The diffraction lens part 30 is formed by combining a diffraction lens plate 34 on a glass substrate 32. An adhesive layer 33 is provided between the glass substrate 32 and the diffraction lens plate 34, so that the diffraction lens plate 34 where a diffraction pattern 34a is formed can be attached on the glass substrate 32 by the adhesive layer 33. However, the diffraction lens plate 34 can be also directly coupled on the glass substrate 32 without the adhesive layer 33.

The diffraction lens part 30 is intended for correcting chromatic aberration occurring due to the aspherical surface 23. FIG. 4 is a view explaining a principle on the basis of which the chromatic aberration is corrected by the diffraction lens part 30.

Referring to FIG. 4, since beams emitted from the aspherical surface 23 are condensed at different focus points depending on the wavelength of the beams, the chromatic aberration occurs. That is, a focal length gets short as the wavelength gets short but a focal length of the diffraction lens part 30 gets long as the wavelength gets short, so that a composite focal length is compensated and the chromatic aberration is thus corrected.

In the present invention, one side of the refraction lens 20 is manufactured in the form of the plane surface 21 and the other side of the refraction lens 20 is manufactured in the form of the aspherical surface 23, so that a lens manufacturing process is simplified. The process of manufacturing the lens whose both sides are spherical or aspherical surfaces is complicated and productivity thereof is low as described above. On the contrary, the lens whose only one side is aspherical has an advantage that it can be easily manufactured.

In the meantime, the diffraction lens part 30 is manufactured independent of the refraction lens 20 and the entire chromatic aberration is corrected using the diffraction lens part 30. The diffraction lens part 30 is manufactured by an ultraviolet hardening method, a nano imprinting method, or an injection molding which will be described later. By such methods, manufacturing at a wafer-level and mass-production can be achieved.

The refraction lens 20 and the diffraction lens part 30 are coupled to the lens holder 35. The lens holder 35 has a beam passing cavity 36 passing through the up/down direction at its central portion. A lens mounting groove 37 is formed on the upper portion of the beam passing cavity 36. An epoxy guide groove 38 is formed on the bottom of the lens mounting groove 37. After the refraction lens 20 is mounted on the lens mounting groove 37, an epoxy ‘e’ is injected therein and the epoxy guide groove 38 guides the epoxy ‘e’ so that the epoxy ‘e’ may not flow toward the beam passing cavity 36 or the aspherical surface 23 of the refraction lens 20 when the refraction lens 20 is fixed.

Also, a first mark 39a used for a reference in aligning the position of the diffraction lens part 30 is formed in the upper surface or the lower surface of the lens holder 35 and a second mark 39b that corresponds to the first mark 39a is formed in the diffraction lens part 30. Aligning an optical axis can be easily performed by arranging the lens holder 35 and the diffraction lens part 30 so that the first and second marks 39a and 39b may be aligned in a line.

FIG. 3B is a view illustrating the diffraction lens part 30 formed in the structure of a diffraction pattern 30a on the glass substrate. The diffraction pattern 30a is directly formed on the glass substrate by, e.g., a nano imprinting process.

A lens holder 70 illustrated in FIG. 3C has a beam passing groove 72 at its central portion and a lens mounting groove 37 is formed at the upper portion of the beam passing groove 72. A diffraction lens plate 34 where a diffraction pattern 34a is formed is coupled on the lower surface of the lens holder 70 by an adhesive layer 33.

FIG. 3D is a view illustrating the lens holder formed integrally with the diffraction lens part. A lens holder 75 illustrated in FIG. 3D has a beam passing groove 77 and a lens mounting groove 37 is formed at the upper portion of the beam passing groove 77. Further, a diffraction pattern 78 is integrally formed on a lower surface of the lens holder 75. Lens holders 70 and 75 having beam passing grooves 72 and 77 illustrated in FIG. 3C or FIG. 3D can be manufactured using an injection molding. The lens holders 70 and 75 are made of a light transmissive material so that light can be transmitted through the beam passing grooves 72 and 77. Also, referring to FIG. 3E, it is possible to directly attach the refraction lens 20 on the upper surface of the lens holder 75 instead of mounting the refraction lens 20 in the lens holder along the lens mounting groove.

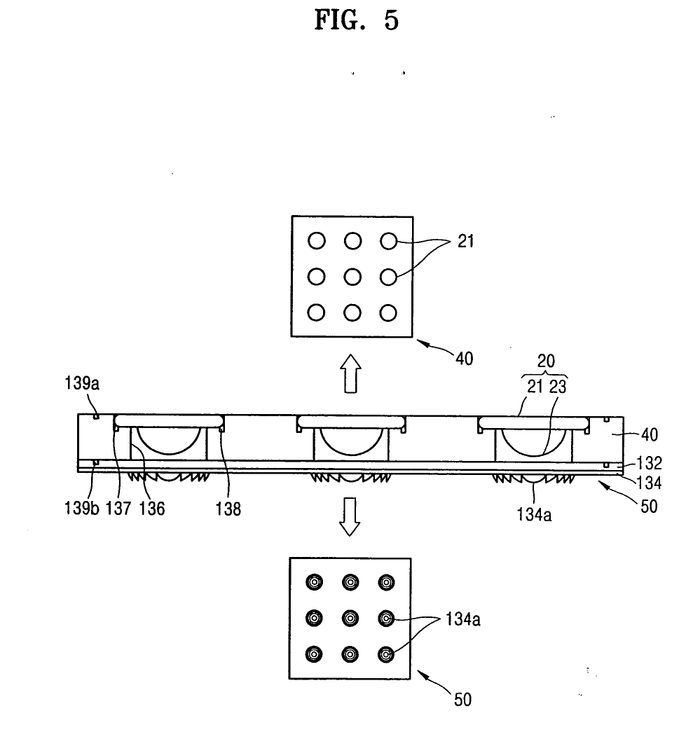

FIG. 5 is a view of a hybrid lens array of the present invention arranged and formed in an array structure. To extend the refraction lens 20 to the form of an array, a lens holder array 40 and a diffraction lens array 50 having a diffraction pattern 134a formed in the form of an array are manufactured and the refraction lens 20 is manufactured by a mechanical processing. Next, the diffraction lens array 50 and the refraction lens 20 are assembled and fixed to the lens holder array 40.

The hybrid lens array of the present invention has a plurality of beam passing cavities 136 and lens mounting grooves 137 formed on the upper portion of the beam passing cavities 136. Refraction lenses 20 each having a plane portion 23 and an aspherical portion 21 inserted into each of the beam passing cavities 136 are arranged in the lens mounting grooves 137. The diffraction lens array 50 includes a glass substrate 132 and a diffraction lens plate 134 having a plurality of diffraction patterns 134a. The diffraction lens array 50 is coupled to a lens holder array 40. At this point, the diffraction lens plate 134 is coupled so that each of the diffraction patterns 134a may be positioned to correspond to each of the beam passing cavities 136. An adhesive layer (not shown) can be further provided between the diffraction lens plate 134 and the glass substrate 132.

The lens holder array 40 can be manufactured by a photo process or an injection molding. Since the manufacturing method using the photo process or the injection molding is already known in the art, detailed description thereof will be omitted.

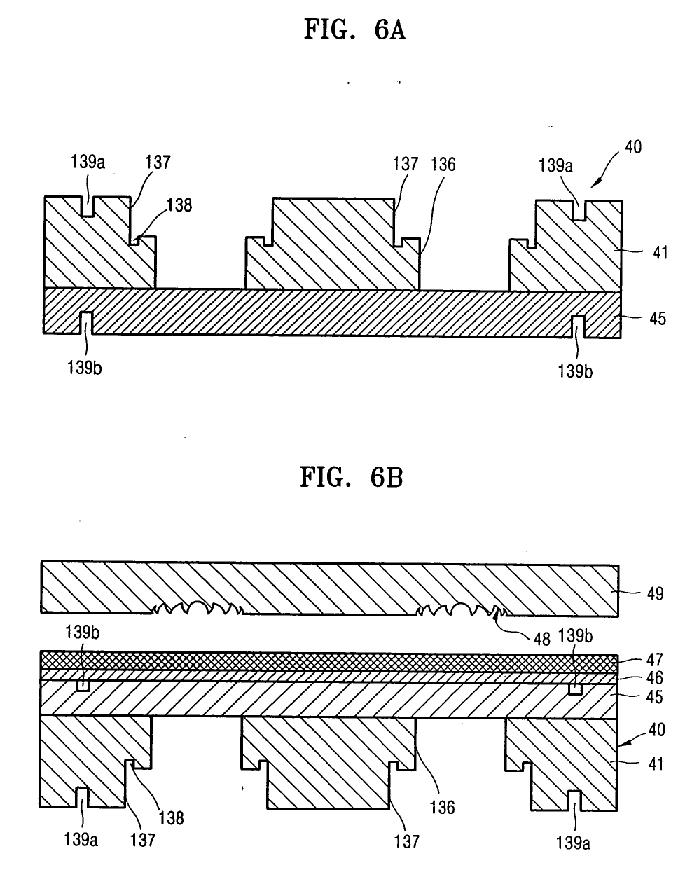

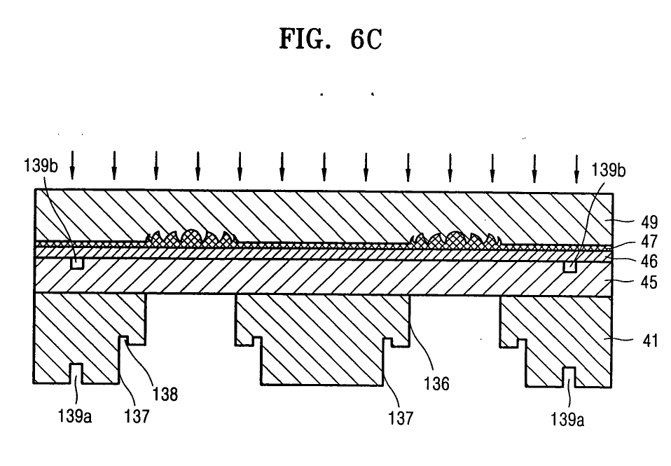

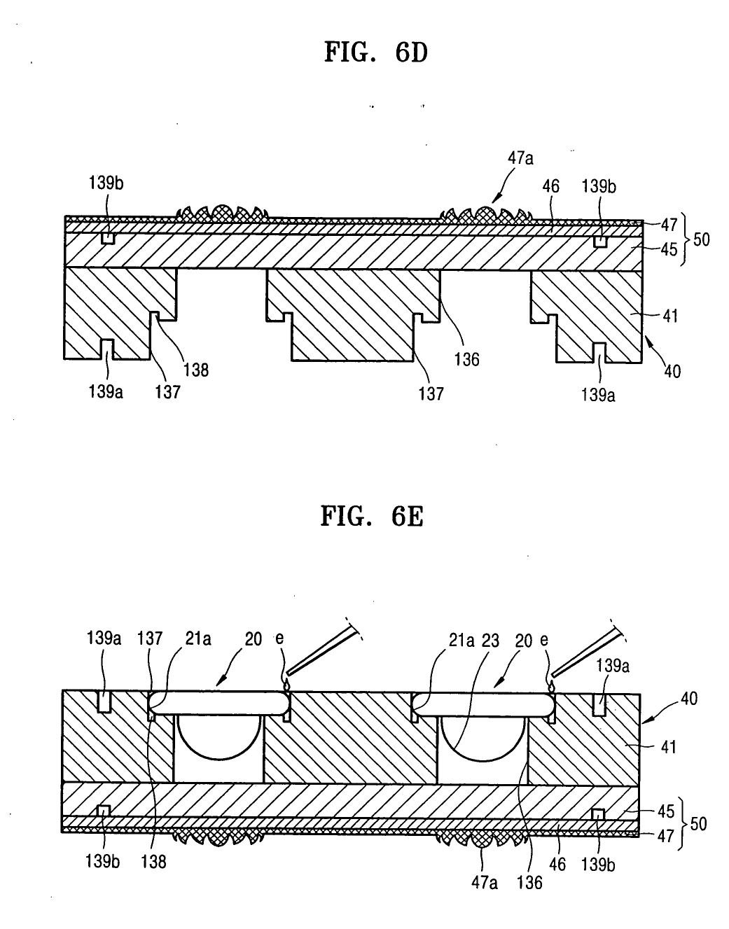

FIGS. 6A through 6E are views illustrating a method of forming the diffraction lens array 50 in the lens holder array 40 using an ultraviolet hardening process and of arranging the refraction lens 20 in the lens holder array 40.

The lens holder array 40 has a plurality of beam passing cavities 136 formed on a substrate 41. A lens mounting groove 137 is formed on the upper portion of the beam passing groove 136. A first mark 139a for use in aligning the diffraction lens array 50 is formed in the upper surface or the lower surface of the lens holder array 40. A glass substrate 45 is attached on a lower surface of the lens holder array 40. The glass substrate 45 has a second mark 139b that corresponds to the first mark 139a such that the second mark 139b can help a position alignment when the glass substrate 45 is attached on the lens holder array 40.

Next, referring to FIG. 6B, an ultraviolet-hardened material 47 in molten state is spread on the glass substrate 45 using a spin coating process and a polymer mold 49 having diffraction patterns 48 is positioned thereon. An adhesive material 46 is disposed between the ultraviolet-hardened material 47 and the glass substrate 45. The ultraviolet-hardened material 47 may have a refractive index of more than 1.5 and may be a material whose inner light transmittance is 95% or more. Also, the material may have an excellent adhesive property and be easily detachable from the polymer mold 49 and have a refractive index that does not change sensitively depending on a temperature. Particularly, the ultraviolet-hardened material 47 should be a material that can be hardened when an ultraviolet in the wavelength band of 200-300 nm is illuminated. The polymer mold 49 is disposed on the ultraviolet-hardened material 47 so that the diffraction patterns 48 may correspond to the beam passing cavity 136. The diffraction patterns 48 are formed to have a Fresnel lens' shape to perform a chromatic-aberration correcting function as well as a condensing function.

The ultraviolet-hardened material 47 is molded into the same shape as the diffraction pattern 48 by pressurizing the polymer mold 49 on the ultraviolet-hardened material 47 as illustrated in FIG. 6C. Both the polymer mold 49 and the ultraviolet-hardened material 47 may be made of a transmissive material having high light transmittance. The ultraviolet-hardened material 47 is hardened by illuminating an ultraviolet to an upper portion of the polymer mold 49. FIG. 6D illustrates a desired diffraction pattern part 47a is formed with the upper portion of the polymer mold 49 removed.

FIG. 6E illustrates the refraction lens 20 is aligned and coupled to a structure where the diffraction lens array 50 is coupled with the lens holder array 40. At this point, the refraction lens 20 is inserted into the lens mounting groove 137 and an epoxy ‘e’ is injected into the lens mounting groove 137. The epoxy ‘e’ flows into a guide groove 138 by way of the lens mounting groove 137. Since a flange 21a of the plane surface 21 of the refraction lens 20 is rounded, the position of the refraction lens 20 is automatically aligned before the epoxy ‘e’ is hardened. In other words, while the epoxy ‘e’ is still flowing, the refraction lens 20 automatically balances and thus is aligned due to viscosity of the epoxy. The epoxy is hardened with the refraction lens 20 automatically aligned, so that the refraction lens 20 is fixed. Therefore, the present invention has an advantage that a separate process of centering the refraction lens 20 is not required. Further, in the case where the refraction lens is an ultra-small microlens, it is impossible to align the refraction lens through the centering process. However, the method of automatically aligning the refraction lens using the epoxy as described above can be advantageously applied to the microlens.

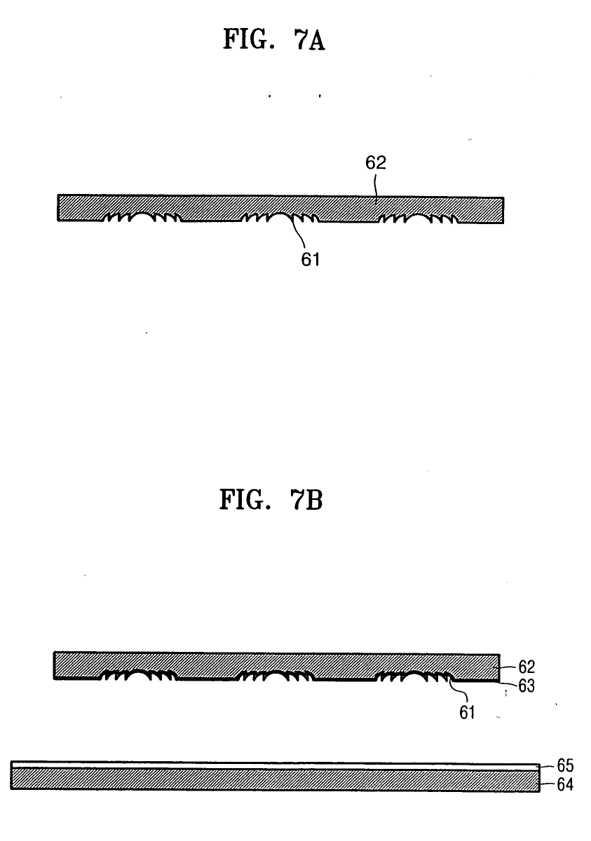

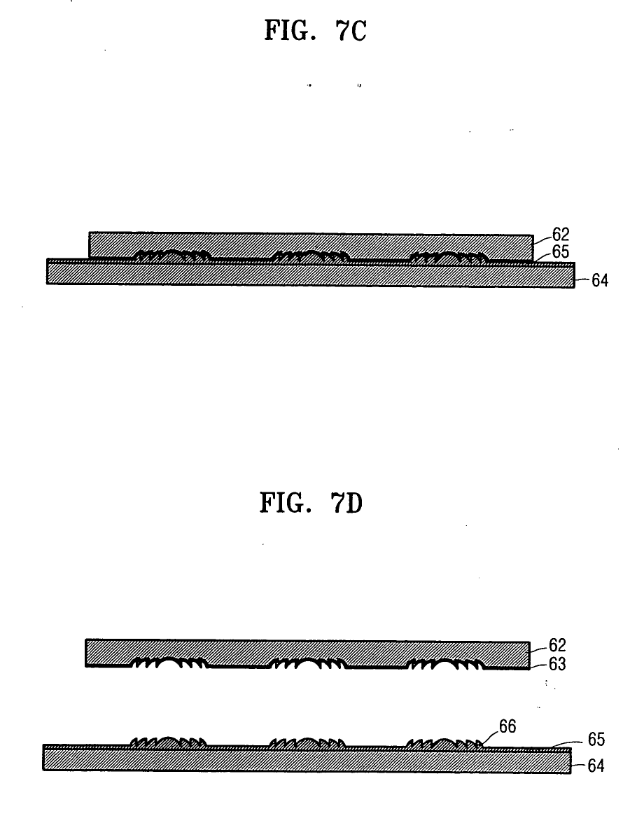

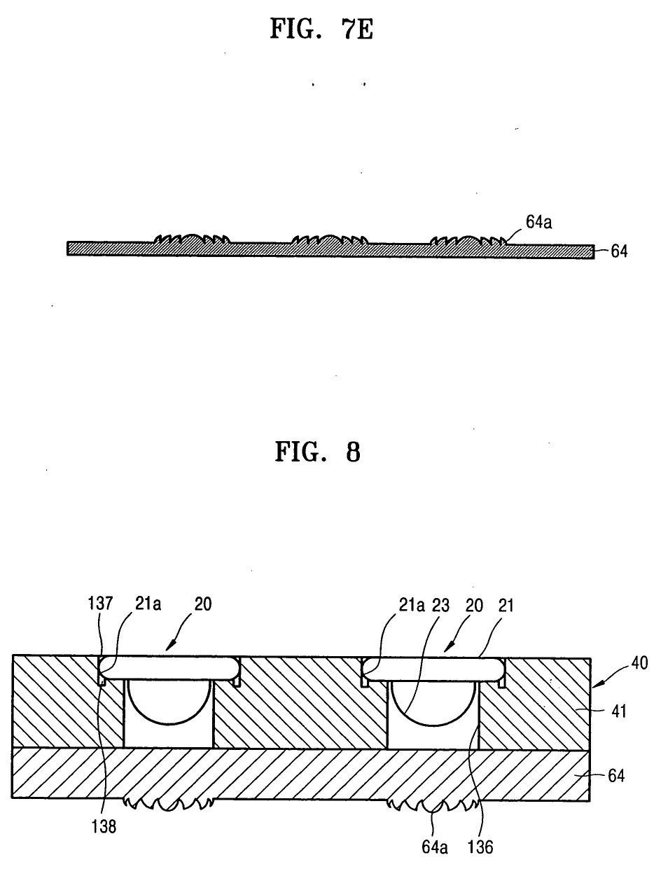

In the meantime, in addition to the method of manufacturing the diffraction lens part using the ultraviolet hardening process, it is possible to manufacture the diffraction lens part using a nano imprinting process. The nano imprinting technology can easily form a nano pattern and be applied to mass-production and thus has an advantage that process yield is high. Description will be made below with reference to FIGS. 7A through 7E.

Referring to FIG. 7A, a template 62 where diffraction lens patterns 61 are formed is prepared first. Next, the template 62 is positioned to correspond to a substrate 64 as illustrated in FIG. 7B. A polymer 65 is spread on the substrate 64. The substrate 64 can be a silicon substrate, a quartz substrate, or an aluminium substrate. A thermoplastic resin such as polymethlmethacrylate (PMMA) can be generally used for the polymer 65 formed on the substrate 64. Here, the template 62 is formed using a material having high light transmittance, and an ultraviolet-hardened material in molten state is used for the polymer. For easy separation of the template 62 from the polymer 65 on the substrate 64, a pre-process of forming a separation layer 63 on the diffraction lens patterns 61 may be performed.

Next, referring to FIG. 7C, the template 62 is fused on the substrate 64 by pressurizing the template against the substrate 64. At this point, the diffraction lens patterns 61 formed on the template 62 are imprinted on the polymer 65. Since both the template 62 and the polymer 65 are made of a light transmissive material having high light transmittance, the polymer 65 is hardened by illuminating an ultraviolet from an upper side of the template 62 during the pressuring process.

Referring to FIG. 7D, if the template 62 is separated from the substrate 64, diffraction lens patterns 66 formed on the polymer 65 can be obtained. Next, the refraction lens patterns are transferred to the substrate 64 by a reactive ion etching (RIE) as illustrated in FIG. 7E. It is possible to easily obtain the diffraction lens array in this manner using the template 62, where a plurality of diffraction lens patterns is formed. That is, the diffraction pattern array 64a can be directly transferred on the substrate 64 through the above-described process.

FIG. 8 illustrates the substrate 64 is coupled to the lens holder array 40.

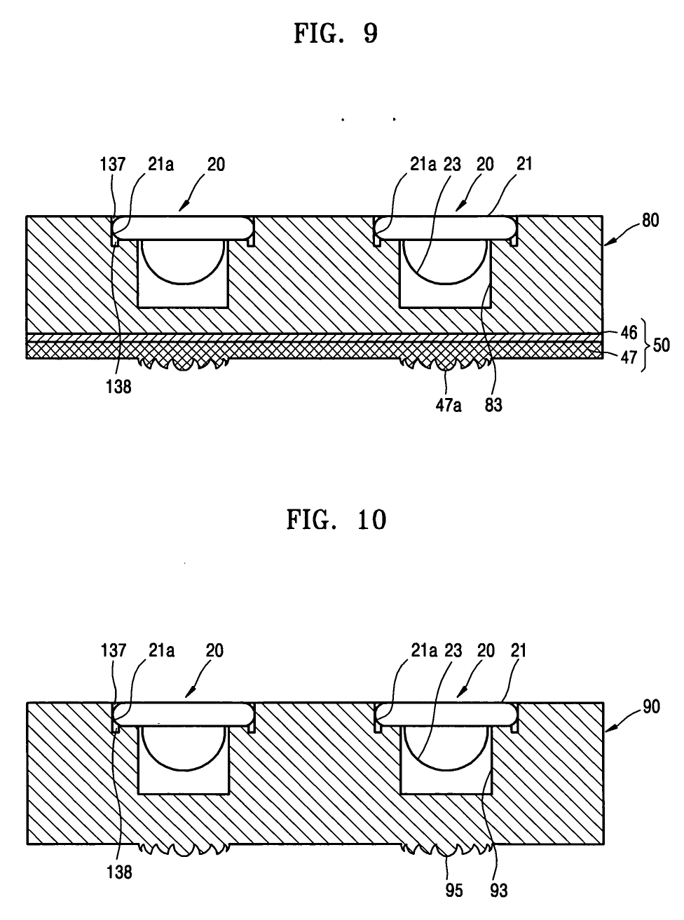

Referring to FIG. 9, a plurality of beam passing grooves 83 are formed in the form of an array in the lens holder array 80 and the diffraction lens plate 47 is coupled to the lower surface of the lens holder array 80 by the adhesive layer 46.

Referring to FIG. 10, a plurality of beam passing grooves 93 are formed in the form of an array in a lens holder array 90 and each of diffraction pattern parts 95 is formed on a position that corresponds to each of the beam passing grooves 93 in the lens holder array 90. Since the lens holder array 90 illustrated in FIG. 10 integrally has the diffraction pattern array, a process of assembling lens parts is not required, so that the manufacturing process is simplified. Each of the refraction lenses 20 is coupled into each of the lens mounting grooves 137 in the lens holder array 90.

The hybrid lens manufactured by the present invention includes the refraction lens having the plane surface and the aspherical surface and the diffraction lens of a Fresnel lens type and thus can function as an objective lens. If light emitted from a light source is incident to the objective lens, the light is refracted by the diffraction lens part first, and condensed by the refraction lens to form a fine optical spot close to a diffraction limit. Accordingly, the refraction lens has a small burden in its refraction power required for condensing light, so that a burden of realizing a high NA is reduced when manufacturing a lens. That is, the refraction power is distributed to the refraction lens and the diffraction lens part, so that manufacturing the refraction lens using the mechanical process gets easy. Therefore, since a material of a low refractive index and a material of a high refractive index can be simultaneously used unlike a conventional lens, it is possible to realize a lens having high refraction power while having an NA similar to the conventional lens, in the form of a small-sized lens.

As described above, the present invention provides the hybrid lens unit including the refraction lens and the diffraction lens part, thereby simplifying the manufacturing process and correcting chromatic aberration occurring at the refraction lens using the diffraction lens part.

Also, the present invention manufactures the hybrid lens by arranging the hybrid lenses in the form of an array, so that the hybrid lens can be manufactured through mass-production and the small-sized refraction lens can be easily assembled and manufactured.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A hybrid lens unit comprising:
a lens holder having a beam passing cavity having a lens mounting groove on an upper portion of the beam passing cavity;
a refraction lens having a plane portion mounted on the lens mounting groove and an aspherical portion inserted into the beam passing cavity; and
a diffraction lens part coupled to a lower portion of the lens holder to face the aspherical portion.

2. The unit of claim 1, wherein the diffraction lens part comprises a glass substrate and a diffraction lens plate and a diffraction pattern part coupled on the glass substrate and positioned to correspond to the beam passing cavity.

3. The unit of claim 2, wherein the diffraction pattern part is arranged to face an outside of the beam passing cavity.

4. The unit of claim 2, wherein an adhesive layer is further provided between the glass substrate and the diffraction lens plate.

5. The unit of claim 1, wherein the plane portion has a round-type flange on an outer circumferential surface thereof.

6. The unit of claim 1, wherein the lens mounting groove comprises an epoxy guide groove.

7. The unit of claim 1, wherein a first mark aligning a position of the diffraction lens part is formed on an upper surface or a lower surface of the lens holder and a second mark that corresponds to the first mark is formed on the diffraction lens part.

8. The unit of claim 1, wherein the diffraction lens part has a diffraction pattern part formed on a position that corresponds to the beam passing cavity on a glass substrate.

9. The unit of claim 8, wherein the diffraction pattern part is formed to face an outside of the beam passing cavity.

10. A hybrid lens unit having a hybrid lens used for an objective lens condensing a beam on a storage medium, the unit comprising:
a lens holder having a beam passing cavity having a lens mounting groove on an upper portion of the beam passing cavity;
a refraction lens having a plane portion mounted on the lens mounting groove to face the storage medium and an aspherical portion inserted into the beam passing cavity; and
a diffraction lens part having a plane arranged to face the aspherical portion and a diffraction pattern part arranged toward an outside of the beam passing cavity, and coupled to a lower surface of the lens holder.

11. The unit of claim 10, wherein the lens mounting groove comprises an epoxy guide groove.

12. A hybrid lens unit comprising:
a lens holder having a beam passing groove;
a refraction lens having a plane portion arranged toward an outside of the beam passing groove and an aspherical portion inserted into the beam passing groove; and
a diffraction lens part coupled to a lower portion of the lens holder to face the aspherical portion.

13. The unit of claim 12, wherein the diffraction lens part comprises a diffraction lens plate having a diffraction pattern part formed on a position that corresponds to the beam passing groove.

14. The unit of claim 12, wherein the diffraction pattern part is formed integrally with the lens holder.

15. The unit of claim 12, wherein a lens mounting groove into which the diffraction lens is seated is formed on an upper portion of the beam passing groove.

16. A hybrid lens array comprising:
a lens holder array where lens holders each having a beam passing cavity having a lens mounting groove on an upper portion of the beam passing cavity are arranged in an array structure;
refraction lenses each having a plane portion mounted on the lens mounting groove and an aspherical portion inserted into the beam passing cavity; and
a diffraction lens array having diffraction pattern parts each arranged to correspond to the beam passing cavity, and coupled to the lens holder array.

17. The array of claim 16, wherein the diffraction lens array comprises a glass substrate and a diffraction lens plate having the diffraction pattern parts formed in an array structure.

18. The array of claim 16, wherein each of the diffraction pattern parts of the diffraction lens array is arranged to face an outside of the beam passing cavity.

19. The array of claim 17, wherein an adhesive layer is further provided between the glass substrate and the diffraction lens plate.

20. The array of claim 16, wherein the plane portion has a round-type flange on an outer circumferential surface thereof.

21. The array of claim 16, wherein the lens mounting groove comprises an epoxy guide groove.

22. The array of claim 16, wherein a first mark aligning a position of the diffraction lens array is formed on an upper surface or a lower surface of the lens holder array and a second mark that corresponds to the first mark is formed on the diffraction lens array.

23. A hybrid lens array comprising:
a lens holder array having lens holders each having a beam passing groove and arranged in an array structure;
refraction lenses having a plane portion positioned toward an outside of the beam passing groove and an aspherical portion inserted into the beam passing groove; and
a diffraction lens array having diffraction pattern parts each arranged to correspond to the bean passing groove, and coupled to the lens holder array.
